(19) United States
(12) Patent Application Publication
(10) Pub. No.: US 2019/0223023 A1
(43) Pub. Date: Jul. 18, 2019

(54) SYSTEM AND METHOD FOR AN INTEGRATED VIRTUAL CUSTOMER PREMISES EQUIPMENT

(71) Applicant: NETSIA, INC., Sunnyvale, CA (US)

(72) Inventors: CAN ALTAY, ISTANBUL (TR); FEVZI DURGAN, ISTANBUL (TR); SINAN TATLICIOGLU, ISTANBUL (TR)

(21) Appl. No.: 15/873,861

(22) Filed: Jan. 17, 2018

(51) Int. Cl. H04W 16/02; H04L 12/24; H04W 16/18; H04W 4/08; H04W 4/50; H04W 28/24

(52) U.S. Cl. CPC H04W 16/02; H04L 41/0813; H04W 28/24; H04W 4/08; H04W 4/50; H04W 16/18

(57) ABSTRACT

Virtual CPE (vCPE) of a plurality of enterprises is sliced according to each enterprise's user-group profiles. Several apparatuses are hosted by a service provider within a control center, which are remotely located: (a) to store different user-group profiles of each enterprise in a policy server, and (b) to remotely control the slicing of various components of the vCPE according to user-group profiles. Several interconnected components are also hosted by the enterprise as the vCPE including a local RAN and associated local core network, a network switch connecting a LAN and various WAN connections, virtualized network functions as well as the local core network, and a control agent apparatus that receives directives from the remote control center and applies these directives onto aforementioned enterprise apparatus components to achieve slicing. The vCPE is sliced per user-group, wherein each slice acts as a separate transport-technology-agnostic virtual network segment within the enterprise.

### BACKGROUND OF THE INVENTION

### Field of Invention

The subject matter disclosed herein relates generally to wireline and wireless voice and data communications, and more particularly in supporting slicing of a virtual CPE using Software Defined Networks (SDN), Network Function Virtualization (NFV) and 5G infrastructures.

### Discussion of Related Art

A CPE or ‘customer premises equipment’ refers to equipment provided by a service provider and installed at a customer's location. Usually, the CPE is provisioned, configured, and managed by a service provider, eliminating the need for the customer to maintain an IT group to perform these tasks on site, and hence bringing significant operation cost savings. Historically, CPE referred mainly to landline telephony equipment such as a PBX, but today the term more generally implies a whole range of service provider supplied equipment including routers, switches, hubs, voice gateways, and set-top boxes along with a PBX.

The CPE is sometimes referred as ‘thick’ or ‘thin’ in prior art. The thick CPE typically provides network functions that are virtualized (meaning they can be activated, capacitated and deactivated remotely from the cloud), and hence the name ‘virtualized CPE’. Examples of virtualized network functions are email, web services, deep packet inspection (DPI), and firewall. Such network functions are either hosted on one or more computers, or they are fully embedded in networking hardware such as a switch. As an alternative to thick CPE, a thin CPE has little or no virtualized network functions. The service provider's offering includes Ethernet/DSL/Wi-Fi support, security services (such as IPSec and tunneling) and service assurance by remote monitoring.

At the current time, the virtual CPE may include a wireless infrastructure (such as Wi-Fi access points), but does not integrate with a local cellular infrastructure. The local 4G/LTE cellular infrastructure, also referred as a ‘Private LTE’ in prior art has several micro base stations at the customer premises to form a local radio access network (RAN), wherein mobile traffic routing is performed using a local enhanced core network (EPC), or in short the core network, or shared with the EPC of an operator's mobile network.

Mobile devices such as smart phones and tablets, and a 5G broadband cellular network enable CPE users to receive the same quality of data communications services offered by a wireless or fixed infrastructure. Therefore, a more advantageous virtual CPE would be one that also supports a set of ‘PBX-like’ cellular functions for intra-location voice-over-IP and data services. Furthermore, this infrastructure may connect to multiple operators' network to support outgoing and incoming cellular traffic that is not local.

In one embodiment, a system called integrated virtual CPE is described that includes a local cellular network (RAN and core network) as a new type of virtual network function (VNF) in addition to wireline and wireless local networks, wherein the system is remotely controlled by a service provider. Aforementioned cellular network can run in total isolation from mobile network operators network, or it can connect to one or more mobile operator networks, in which case the users can use their operator-provided telephone numbers as opposed to special private numbers. Another key aspect of this disclosure is slicing of the integrated virtual CPE according to user-group profiles so as to map users and their applications to different network segments that offer various levels of quality of services.

The concept of slicing is widely known in prior art and achieved using principles of software defined networking (SDN) and network function virtualization (NFV). SDN achieves the decoupling of the control plane from the data plane of forwarding functions, and assigns the control function to a logically centralized controller, which is the ‘brain’ of the network. Similarly, NFV decouples network functions from the underlying hardware so that they can run as software images on commercial off-the-shelf hardware anywhere in the network, and can be controlled centrally. The key enablers for a sliceable integrated virtual CPE are therefore (a) a centralized (remote) control, or a remote control along with a local control component totally separated from the transport data network, and (b) policy services that store the user-group profiles and associated network usage policies.

The SDN architecture, with its software programmability, provides agile and automated network configuration and traffic management based on open standards. Network operators, exploiting the programmability of the SDN architecture, are able to dynamically adjust the network's flows to meet the changing needs while optimizing the network resource usage. The controller is the central control point of an SDN and hence vital in the proper operations of network switches. The controller configures the packet forwarding behavior of switches by setting packet-processing rules in a so-called ‘flow table’. A rule in the flow table is comprised of a match criteria and actions. The match criteria are multi-layer traffic classifiers that inspect specific fields in the packet header (source MAC address, destination MAC address, VLAN ID, source IP address, destination IP address, source port, etc.), and identify the set of packets to which the actions will be applied. The actions may involve modification of the packet header and/or forwarding through a defined output port. Each packet stream that matches the criteria is called a ‘flow’. Using flow-tables, the controller can (a) direct traffic originated from different users in a local network and targeted to an outside destination to different types of networks (e.g., MPLS, private line, DSL etc.), (b) allocate switch buffers and processing resources to different type of users to achieve different grades of quality of service (e.g., low latency and high throughput).

NFV uses all physical network resources as hardware platforms for virtual machines (VMs) on which a variety of network-based services can be activated and deactivated on an as needed basis. The NFV platform software is responsible for dynamically reassigning VNFs due to failures and changes in traffic loads, and therefore plays an important role in achieving high availability. A key software component called ‘orchestrator’, which provides management of the virtualized services is responsible for onboarding of new network services and virtual network function packages, service lifecycle management, global resource management, and validation and authorization of NFV resource requests. Orchestrator can remotely activate a collection of virtual functions virtual machines in one or more networks. European Telecommunications Standards Institute (ETSI) provides a comprehensive set of standards defining NFV Management and Orchestration (MANO) interface in various standards documents. For example, the Orchestrator to VNF interface is defined as the Ve-Vnfm interface. There are several other interfaces that tie NVF to the Operations Systems (OSS) and Business Systems (BSS) systems. All of these interfaces and their functions are publicly available in ETSI NVF Reference Architecture documents in ETSI's web pages.

SDN is most commonly applicable to slicing transport services such as switching and routing. Recently, slicing of radio access networks (RAN)s using SDN principles has also emerged in the standards (3GPP release 4). Furthermore, enhanced core network (EPC) slicing has also emerged in 3GPP release 5, wherein the Mobility Management Entity (MME) function has been sliced and virtualized. The controller creates a ‘RAN slice’ of a base station with allocated uplink and downlink resource blocks for the slice-specific user plane, and [symbol] associated uplink and downlink schedulers selected from a list of available schedulers. This process achieves a time-frequency-space radio resource block assignment to different RAN slices. Some wireless link functions, such as handoff parameters, that are known to be common in all slices may also be included in a slice definition. Although RAN slicing seems significantly different in nature than slicing the EPC and the transport network, the only difference lies in the description of the resources to be partitioned among different slices.

The system of this disclosure is used to (a) enable remote (cloud based) control and management of CPE's local and WAN data communications resource usage, (b) partition entire set of network resources of the CPE (slicing), (c) manage and assign network services usage according to user profiles or policies (profiling), (d) provide a consistent quality of service across all local wireline, cellular and Wi-Fi access, and WAN in a slice (transport-agnostic), and (e) enable same network usage experience across different user equipment (UE-agnostic).

The disclosed subject matter has an integrated virtual CPE that is comprised of a plurality of interconnected hardware components: (a) router/switch/hub, (b) server (computer) hosting a plurality of virtual network functions including a core network, and (c) micro base station. Wire-line and radio networks interconnect these components locally. The control of said integrated virtual CPE is performed by a service provider's control infrastructure, which is comprised of a computer that hosts the software of (a) a policy server, (b) an SDN controller, (c) an NVF orchestrator and (d) an LTE controller, all located remotely from the integrated virtual CPE. These are software components that may run concurrently on the same computer, or on different computers. The control infrastructure is securely partitioned to support many virtual CPEs. The policy server is responsible to configure and spread policies that are applicable to an enterprise or its partitioned user-groups to the SDN controller, NFV orchestrator and LTE controller so that traffic originated and terminated by various types of end devices of the user are treated similarly. In an embodiment, a ‘local core network’ is deployed as a new type of virtualized network function to locally route mobile traffic. The aforementioned local traffic does not exit towards the mobile operator's core network because there is a local core network. A special ‘control agent’, which is controlled and configured by the centralized ‘LTE controller’ is also part of the invention. An embodiment of the control agent applies control and configuration actions for slicing requested by the LTE controller onto (a) the core network's MME and S/P-GW components using their native interfaces and (b) the RAN controllers. Any cellular traffic that is destined to an IP address outside the realm of the enterprise is routed by local core network towards the attached mobile operator's core network. A ‘virtual MME’ is part of the local core network that is shared across the local core network and the core network of its remote mobile operator. A ‘virtual S-GW’ per attached mobile network is also included in the local core network to route traffic towards an attached mobile network. According to an aspect of this invention multiple mobile operator telephone numbers are also supported seamlessly.

An integrated virtual CPE slice is generated per user-group wherein a user-group profile includes: percentage/ratio of uplink and downlink RAN resource blocks, a virtual portion of the MME configured with the IP addresses of users and associated S-P Gateways. It also includes the partitioning of the SDN switch resources (e.g., buffers, ports and processing capacity), transport network resources (e.g. transmission bandwidth), and virtual network function capacity according to a policy.

Embodiments of the present invention are an improvement over prior art systems and methods.

### SUMMARY OF THE INVENTION

In one embodiment, the present invention provides a slicing method for customer premises equipment (CPE), wherein each user-group or application type is mapped to a local network slice according to a profile, wherein slicing provides a subdivision of all network resources associated with the CPE comprising a local radio access network (RAN) and an associated local core network (CN), a local area network (LAN), at least one virtualized network function (VNF), and at least one programmable switch, the method executed by a special control agent comprising the steps of: (a) receiving directives to control the control agent from a control infrastructure hosted in a remote site, the remote site storing user-group information and associated profiles, and (b) slicing components of the CPE according to the storing user-group information and associated profiles by assigning different network resources to user groups by programing any of, or a combination of the following: the local RAN, Mobility Management Entity (MME) and Packet Data Network Gateway (P-GW) components of the local CN, the at least one VNF, and the at least one programmable switch.

In another embodiment, the present invention provides a system providing a sliceable local communications network further providing wire line, wireless, and cellular data communications services to a group of users, and that is comprised of at least a local area network (LAN), a local Radio Access Network (RAN) and associated local core network (CN) and at least one programmable switch interconnecting the local CN, a local data network and at least one wide area network (WAN), wherein customer premises equipment (CPE) is controlled by a local control agent, which is in communications with a remote control center, wherein groups of users of the CPE with different profiles are given different slices of the RAN, CN, at least one programmable SDN switch, at least one virtualized network function (VNF), and transport facilities, the system comprising: (a) a policy server of the remote control center that stores user-group policies and associated UE data such as UE International Mobile Subscriber Identity (IMSI), Media Access Control (MAC) address, and username/password; (b) an orchestrator of the remote control center programmed by the policy server to control either the control agent or the VNF directly by sending directive to slice the VNF; (c) an SDN controller of the remote control center programmed by the policy server to control the control agent or the at least one programmable SDN switch directly by sending directive to slice the at least one programmable switch; (d) a Long-Term Evolution (LTE) controller of the remote control center programmed by the policy server to send directives to the control agent for slicing a Mobility Management Entity (MME), the RAN and a Packet Data Network Gateway (P-GW); and (d) the control agent residing within the customer premises equipment: (i) receiving directives from the remote control center, and (i)) applying said directives to local network components.

In yet another embodiment, the present invention provides an article of manufacture comprising non-transitory computer storage medium storing computer readable program code which, when executed by a processor in a single node, implements a slicing method for customer premises equipment (CPE), wherein each user-group or application type is mapped to a local network slice according to a profile, wherein slicing provides a subdivision of all network resources associated with the CPE comprising a local radio access network (RAN) and an associated local core network (CN), a local area network (LAN), at least one virtualized network function (VNF), and at least one programmable switch, the medium comprising: (a) computer readable program code executed by the processor to receive directives to control the control agent from a control infrastructure hosted in a remote site, the remote site storing user-group information and associated profiles, and (b) computer readable program code executed by the processor to slice components of the CPE according to the storing user-group information and associated profiles by assigning different network resources to user groups by programing any of, or a combination of the following: the local RAN, Mobility Management Entity (MME) and Packet Data Network Gateway (P-GW) components of the local CN, the at least one VNF, and the at least one programmable switch.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates a simple virtualized CPE according to prior art.

FIG. 2 illustrates use of micro base stations according to prior art.

FIG. 3 illustrates a Private LTE according to prior art.

FIG. 4 illustrates the radio network components of integrated virtualized CPE according to invention.

FIG. 5 illustrates the control network of the radio network components of integrated virtualized CPE according to invention.

FIG. 6 illustrates the integrated virtual CPE and the control network according to invention.

FIG. 7 illustrates the integrated virtual CPE components according to invention.

FIG. 8 illustrates three exemplary integrated virtual CPE slices.

FIGS. 9A and 9B illustrate two use case scenarios.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a network switch or controller) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, router, base station or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers. A base station is a network equipment that has antennas to transmit and receive radio signals to connect user equipment such as cell phones to a switched/routed network for voice and data transmission.

An enterprise network is sliced in such a way that a slice is created per user-group wherein the members of the user-group are provided the same grade of service regardless of local transport technology and end device type. The slicing is achieved by an integrated virtual CPE, which is remotely programmed using a control infrastructure located at a service provider's data center. The integrated virtual CPE is comprised of (i) an SDN switch (or multiple SDN switches) that can route traffic to multiple types of access networks (MPLS, Private Line, DSL, Cable, etc.) and that can be remotely controlled by an SDN controller, (ii) at least one sliceable virtualized network function, (iii) a sliceable RAN, (iv) a sliceable core network and (v) a control agent. According to another aspect of this invention the control infrastructure is comprised of said SDN controller, said NFV orchestrator/OSS/BSS, and an LTE controller, all deployed at a remote site such as a service provider's data center and governed by a policy server sends directives to the local control agent. User-groups are profiled according to fixed user identities such as IMSI, MAC address, username/password or variable user identities such as IP addresses. Rules are programmable for each group's total traffic or different traffic types. Each user-group is given a slice of the RAN, a slice of MME component of the core network, a slice of the SDN switch and that of the VNFs such that each slice meets a specific service grade, network capacity and specific security.

In U.S. Pat. No. 9,585,186 B2, Ghai describes a virtual CPE deployment by using a centralized Wi-Fi access gateway and many radio access nodes that are being programmed by the Wi-Fi access gateway that is remote to the radio access nodes serving Wi-Fi end points. However, the scope of the virtual CPE is limited to Wi-Fi service only. There is no disclosure on support of cellular services.

In US 20160036601 A1, Kusano describes a method for control of a non-SDN access network using centralized software defined networking manager, which communicates with the customer premises equipment (CPE) using a local software defined networking agent. The local agent supports the SDN protocol towards the manager and non-SDN protocols towards the access network and represents the entire access network as a single SDN node. However, Kusano only focuses on how to translate SDN protocol to other local protocols, and does not teach how to implement an integrated CPE that supports cellular as well as non-cellular access traffic.

Network slicing is specified per user-group for simplicity in one embodiment. An exemplary set of user-groups of an enterprise can be employees, visitors, management team, and Internet of Things (IOT), each of which has different rights and requirements. In another embodiment, network slicing can be per application type. There are applications that are latency-sensitive (video conferencing and gaming), or high throughput (streaming video) or delay insensitive and low throughput (email). Network slicing defined according to such network performance criteria is inclusive of this invention.

Note while the illustrated examples in the specification discuss mainly on SDN system with a layered Network Function Virtualization (NFV) architecture, embodiments of the invention may be implemented in non-SDN systems. Unless specified otherwise, the embodiments of the invention apply to any controller of the layered network architecture, i.e., they are NOT limited to an SDN controller. In one embodiment, all software components of the remote control center may be hosted on the same computer. In another embodiment, the software components of the remote control center may be distributed to multiple computers for load balancing and improved reliability. The control of VNFs may be through a system named other than orchestrator. Such architectural alternatives should be considered within the coverage of this invention. The terms Enhanced Packet Core (EPC) or core network are used synonymously. The Next Generation Core (NG-Core), being defined by 3GPP, should also be considered with the coverage of this invention, even though its subcomponents are named and distributed differently than the EPC. The terms 4G and LTE are used synonymously. The embodiments apply to 4G and any radio technology beyond 5G.

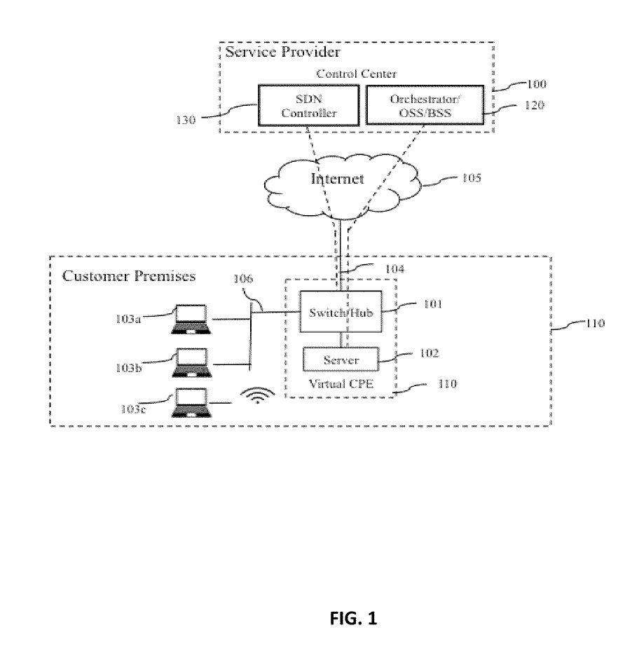

FIG. 1 illustrates an embodiment of virtual customer premises equipment 110 according to prior art. The virtual CPE is comprised of SDN switch 101 that connects Local Area Network (LAN) 106 to Internet 105 and Server 102. Server 102 hosts virtualized network functions (VNF)s used by the customer premises. SDN switch 101 may also have an integrated wireless access point (WAP) to connect user equipment 103c that is using wireless access. User equipment 103a and 103b are connected to LAN 106. Control Center 100 of the Service Provider has SDN Controller 130 that controls switch 101, and Orchestrator 120 that controls VNFs on Server 102. Both Controller 130 and Orchestrator 120 attach to apparatus in the customer premises over the public Internet 105 through secure tunnel connections such as connection 104. SDN Controller 130 sends flow-tables to switch 101 using OpenFlow protocol to configure traffic flows within the local site as well as incoming and outgoing traffic from/to public Internet 105. SDN controller 130 can slice the traffic.

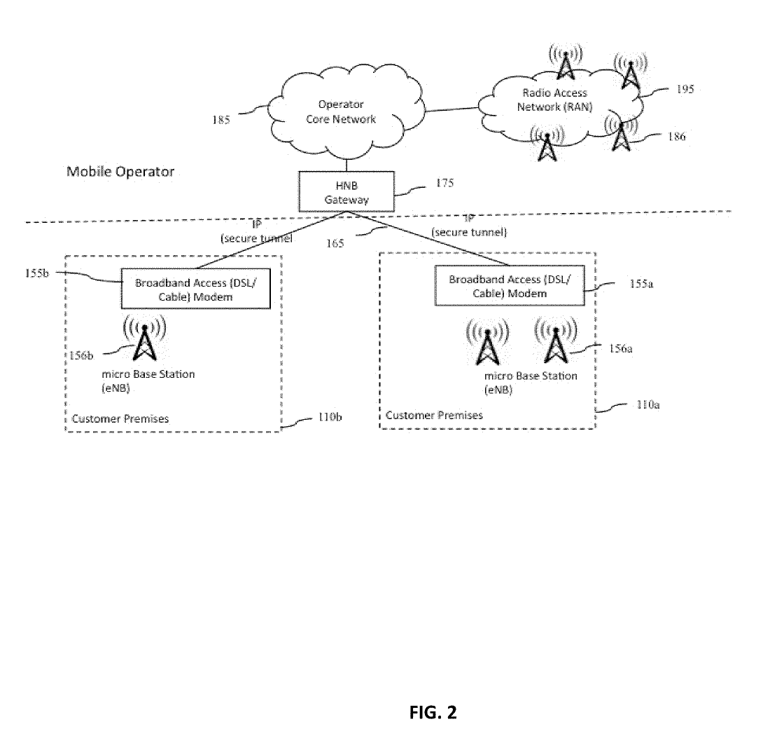

FIG. 2 illustrates customer premises 110a and 110b wherein micro base stations 156a and 156b are deployed, respectively. Micro base stations also known as Home ENodeB (referred as HeNB or HNB) are a cornerstone of a highly scalable radio access network (RAN) in 4G and beyond. The standards define an architecture for the widespread use of micro base stations at residential and enterprise locations to offload macro base stations 186 at the edges of the operator's Radio Access Network (RAN) 195. HNB access network gateway (HNB Gateway) 175 is used to connect micro base stations 156a and 156b to operator's Enhanced Packet Core (EPC)/core network 185 using the standard ‘IuCS’ interface. The connectivity of 156a and 156b to HNB Gateway 175 is achieved via DSL or Cable modems 155a and 155b, respectively, both located at the customer premises. Further note that connectivity 165 is a secure IP tunnel. HNB Gateway 175 aggregates HeNBs to a single network element as viewed from core network 185, and then merges them into the mobile operator's voice, data and multimedia network infrastructure. In this scenario, all IP voice, and data traffic routing functions are provided by the operator's core network.

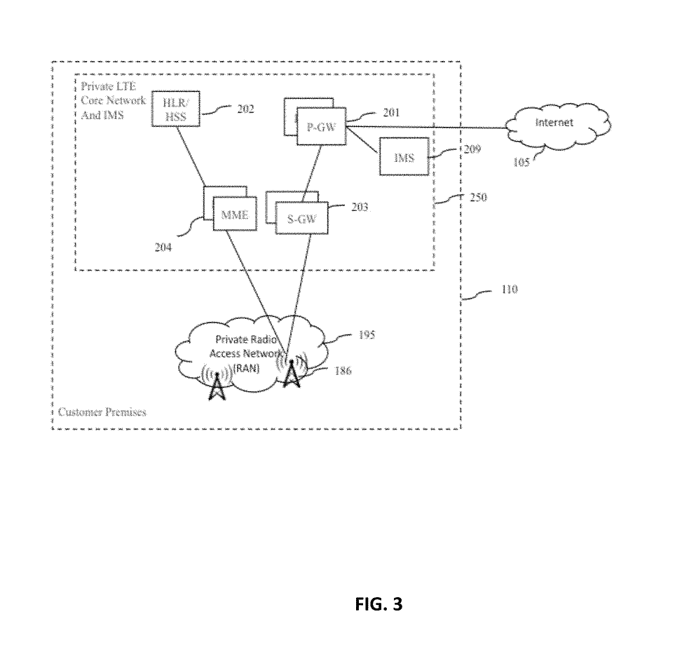

FIG. 3 illustrates an embodiment of customer premises 110 deploying a Private LTE network that is substantially different than the configuration of FIG. 2 because it is independent of mobile operator's network and completely dedicated to the use of a single enterprise. It has self-contained core network 250 and radio access network (RAN) 195 that is comprised of a plurality of HeNB 186. Private LTE of FIG. 3 is advantageous to the configuration of FIG. 2 since the enterprise can customize the use of it according to application types and users. Especially in enterprises that deploy large numbers of Internet of Things (IOTs) that need to be connected with a radio network (such as large factory plant operations or airport field operations), the private LTE solution provides great advantages. The components and functionality of the core network for 4G are defined by a standards group called Third Generation Partnership Project (3GPP) in early 2009. Now, a more advanced core network is being defined by 3GPP for LTE. This new core network is called next generation core (NG core). The key components of the enhanced core network are (a) Mobility Management Entity (MME) 204 that manages each session's states and authenticates and tracks a user across the network using the IP address, (b) Serving Gateway (S-GW) 203 that routes data packets through the access network, (c) Packet Data Node Gateway (P-GW) 201 which acts as the interface between the LTE network and other packet data networks, handles IP address assignment to user equipment, connects to IP Multimedia Subsystem (IMS) 209 and Internet 105, and manages quality of service (QoS), and (d) Home Subscriber Server (HSS) 202 that supports user subscription, location information, name to address resolution, and standard AAA functions. All core network components may run on one or more computers. The users of network are provided with private cellular numbers that are routable only within the private LTE.

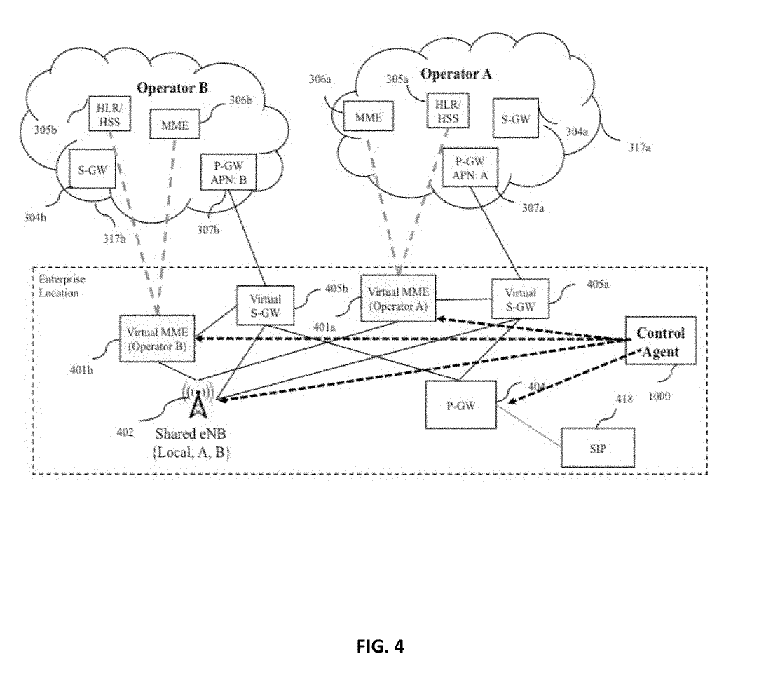

FIG. 4 illustrates an embodiment according to this invention wherein a private LTE network is used within an enterprise but also attached to two mobile operators, operator A and B. This configuration is highly advantageous to Private LTE configuration of FIG. 2 because (a) it can route traffic between the local network and these two operator networks, and (b) the end devices can use their operator core network IP's assigned by the operators as well as local network IP's. If some of the end devices of the enterprise (such as IOTs) are provided local IP's, the traffic to/from these devices are only locally routed. A local RAN 402 is used that is shared between local traffic as well as traffic towards operators A and B. The local core network is comprised of virtual MME's 401a and 401b that are used to control plane functionalities of operator A and B, respectively. Virtual MME's 401a and 402b uses operator hosted HSS 305a and 305b as opposed to a local HSS. Here, P-GW 404 is used only for the traffic staying local. Virtual S-GW 405a is used for traffic originated from or destined to operator A. Similarly, Virtual S-GW 405b is used for traffic originated from or destined to operator B. Both virtual S-GWs can be used for local traffic routing. Operator A's core network contains HSS 305a, S-GW 304a and P-GW 307a. Reciprocally, Operator B's network contains HSS 305b, S-GW 304b and P-GW 307b. For local voice traffic, P-GW 404 is attached to SIP server 418. For Internet bound traffic, it is attached to one of the SDN router(s)/switch(es) connected to the Internet.

Exemplary traffic flows are as follows:
Traffic originated from a UE in local network with an Operator A IP, but destined to a UE with Operator A or B IP but that is not local is sent to Operator A's network via tunnels through virtual S-GW established by virtual MME of Operator A.
Traffic originated from a UE in local network with an Operator B IP, but destined to a UE of Operator A or B that is not local is sent to Operator B's network via tunnels through virtual S-GW established by virtual MME of Operator B.
Traffic originated from a UE of Operator A or B within the local network with a local IP, and destined to another UE of Operator A or B in local network with a local IP is sent to local tunnel to virtual S-GW established by either of the virtual MMEs, and then sent towards local P-GW, thus remain local.
Traffic originated from a UE in Operator A or B network, and destined to a UE in local network with an Operator A or B IP is sent to that Operator's MME, and thereafter sent towards the local virtual S-GW.

According to an aspect of this invention, the local RAN is essentially shared between the users of Operator A and B who are local as well as those users with local IP's, but furthermore, a traffic splitting is applied by keeping local traffic of Operator A and B users within the local core network along with traffic with local IP's. For lawful intercept and billing of the Operator's traffic that remains local, the Operator may need to collect certain data from defined interception points of the local network, which may in turn require a virtual policy and charging rules function (PCRF) directly connected to local P-GW that is locally deployed in the EPC. This function is not shown in the diagrams as they are not pertinent to this embodiment.

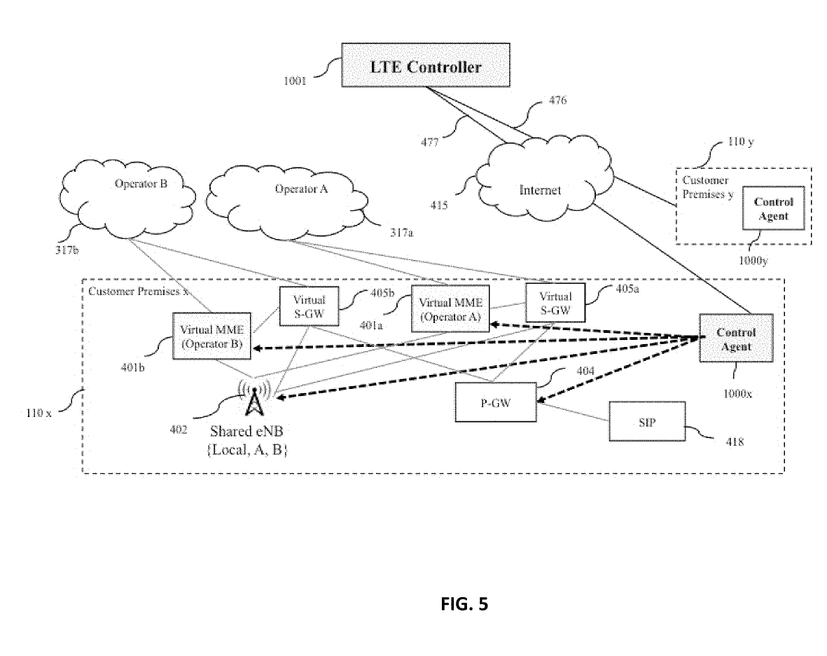

FIG. 5 illustrates LTE Controller 1001, one of the key systems of this invention, that sits in a remote control center of a service provider and controls customer premises networks 110x and 110y. LTE Controller 1001 attaches to Control Agent 1000x and 1000y that reside within the customer's premises of two different enterprises and have direct interfaces to local RAN, the virtual MME, and local P-GW. Here, LTE Controller 1001 sends directives to Control Agent 1000x using interface 477, and in parallel to Control Agent 1000y using interface 476, both interfaces running over public Internet 415 using a secure connection such as a tunnel.

LTE Controller 1001 interface to Control Agents is an open API that is used for status reporting, configuration and statistics of the local RAN and core network. This interface is used to manage the profile database within the remote control center. “RB (Resource Block) Rate”, “Scheduler Type” and “IMSI list” are a few of these profile attributes to be used for the QoS based scheduling of the local RAN and configuration of the MME. Exemplary messages on the interface can be broadly grouped as:
Session Setup Messages—INIT, INIT_ACK
Link Maintenance Messages—ECHO_REQ, ECHO_RSP
Event Reporting Messages—EVENT_RPT
Configuration Messages—CFG_SET_REQ, CFG_SET_RSP
Statistics Reporting Messages—STATS_REQ, STATS_RSP

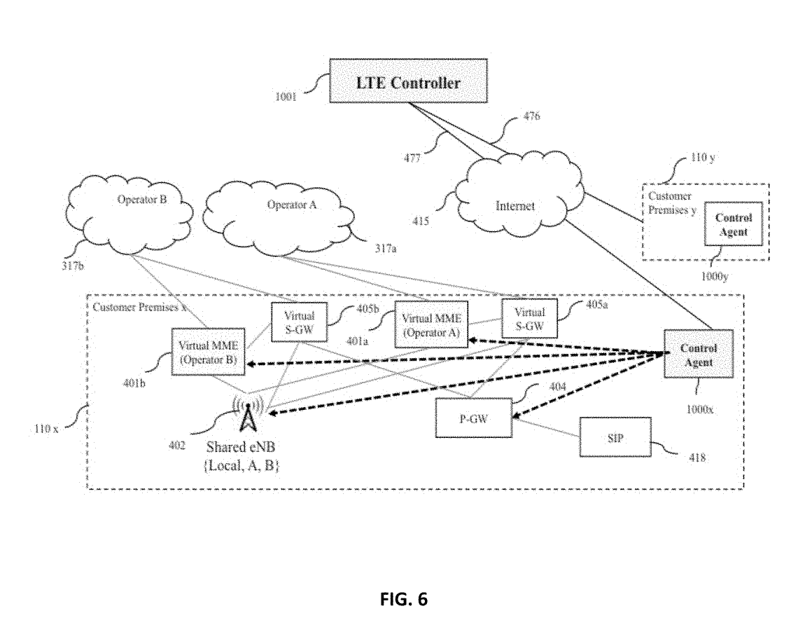

FIG. 6 discloses the solution architecture with the apparatus located at remote control center 100 of the service provider overlaid on the apparatus of the integrated virtual CPE 110 that is controlled by the remote control center. Remote control center 100 controls a plurality of enterprise's integrated virtual CPE 110. At the remote control center 100, policy server 1030 is where each enterprise user-group (or application type) policies are stored. Policy server 1030 sends directives to (a) SDN controller 130 regarding traffic routing policies (QoS, bandwidth reservation, etc.) of each user-group which enable configuration of SDN switch 101 accordingly, (b) orchestrator 120 regarding usage of virtualized network functions by user-groups, and (c) LTE controller 1001 regarding usage of RAN and core network resources by user-groups.

Integrated virtual CPE 110 of FIG. 6 includes SDN switch 110 that is remotely configurable by SDN controller 130 and interconnects (a) various WAN connections for public Internet access to the local area network 604, and (b) the local core network to the public Internet by connecting to P-GW 404 via interface 499. VNF 102 and local core network 603 may be hosted on the same hardware or different hardware. Virtual MIME's 401a and 401b are optional. It is only needed if the local cellular network interconnects to Operator networks. The local P-GW 404 of the core network also attaches to switch 101 to route Internet-bound cellular data.

Control Agent 1000 is the touch point of LTE Controller 1001. In this embodiment, Orchestrator 120 and SDN Controller 130 are assumed to have direct interfaces to VNF 102 and SDN switch 101. In another embodiment (not illustrated), Control Agent 1000 may be the single touch point the Control Center, and thereby acting as a proxy of the SDN controller and orchestrator.

In an embodiment of Control Agent 1000, it has interfaces to several components within the integrated local CPE as well as the remote control center:
Interface 496 to the local Virtual MME to receive information about each local UE attachment, detachment, cell reselection and handover.
Interface 497 to HeNB to send the RAN slice information associated with a UE during the attach procedure.
Interface 498 to P-GW (of the local core network) to send an IP address during a UE attachment (or alternatively pre-configure an IP address pool for each UE user-group).
Interface 477a to LTE Controller to receive RAN slice information in order to configure the local HeNB.
Interface 477b to Orchestrator to manage the capacity of local core network components.
Interface 477c to SDN Controller to send a message during UE attach (such as a packetIN message) as a result of which the SDN Controller can configure the SDN switch.

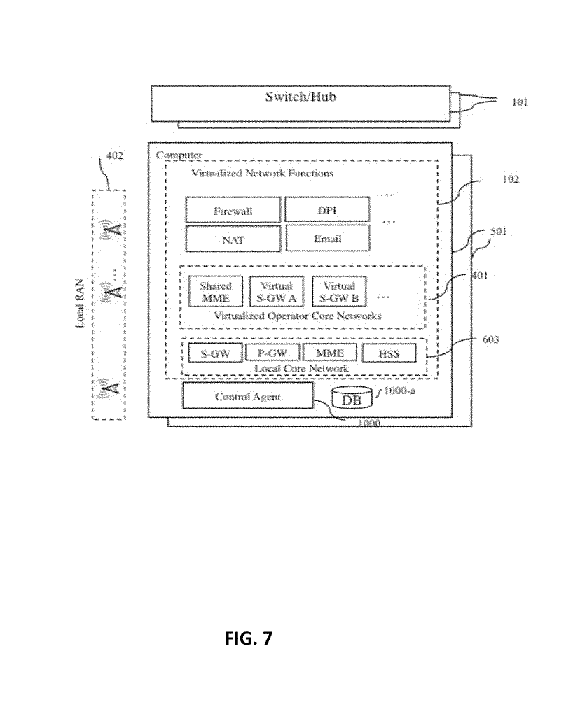

FIG. 7 illustrates grouping of the integrated virtual CPE components. Switch/hub 101 is a separate equipment from computer 501 that hosts (a) generalized virtualized network functions 102, (b) components of local core network 603 (a specialized virtual network function), (c) optional virtualized operator core network subcomponents 401 (a specialized virtual network function), and (d) control agent 1000 and its local database 1000a (which can also be treated as a virtual network function).

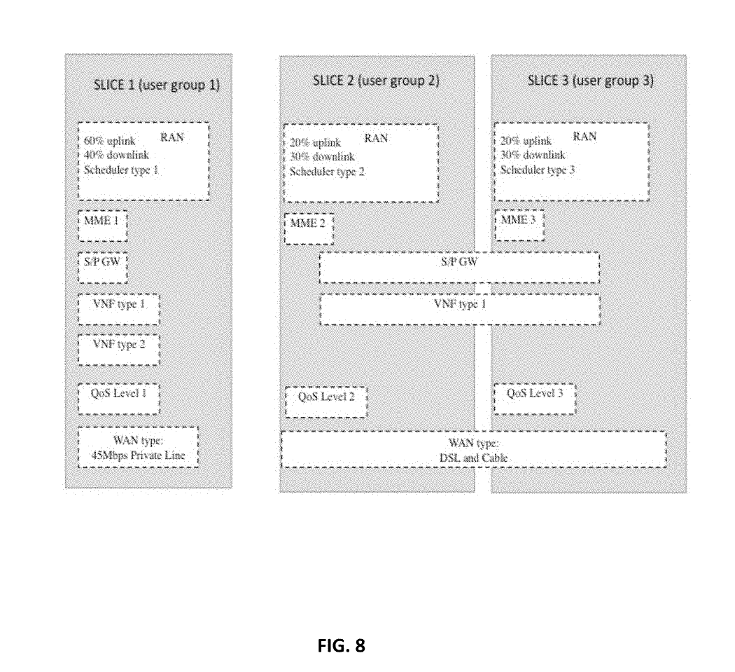

FIG. 8 depicts three exemplary slices of the integrated virtual CPE defined for three types of user-groups within an enterprise. Note that the user-groups of slice 2 and slice 3 are permitted to use only VNF type 1 (web services), while slice 1 uses both VNF type 1 and type 2 (email). While slice 1 has a dedicated S/P GW, the other two slices share the same S/P GW. All three slices use separate virtual MME's. The QoS levels and the WAN connection usage are also configured separately for each user-group. Furthermore, slice 1 and 2 users may be allowed to use mobile operator networks for inbound and outbound calling, while slice 3 may stay purely local (e.g., when the users are IOT). The slice attributes for each user-group are stored within the policy server and attributes relevant to different service types are pushed down to SDN controller, orchestrator and LTE controller.

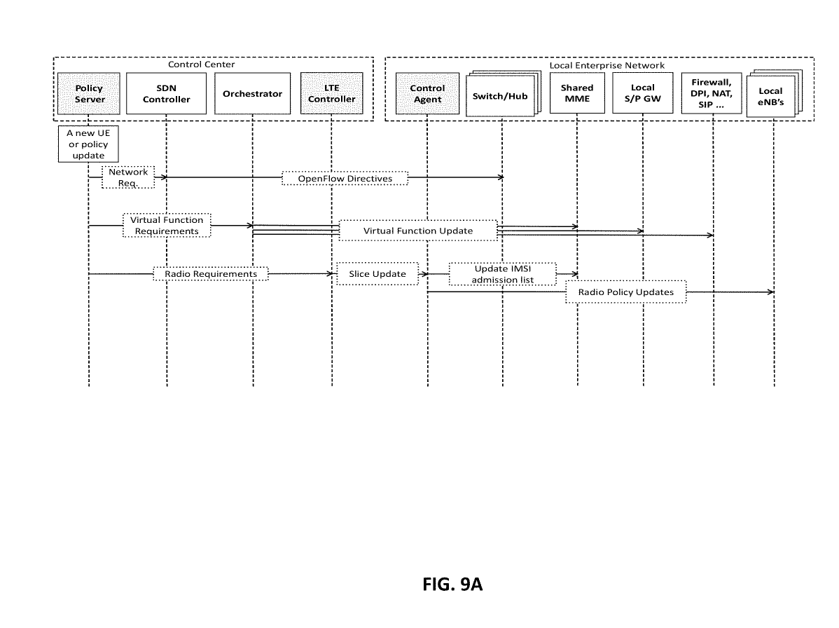

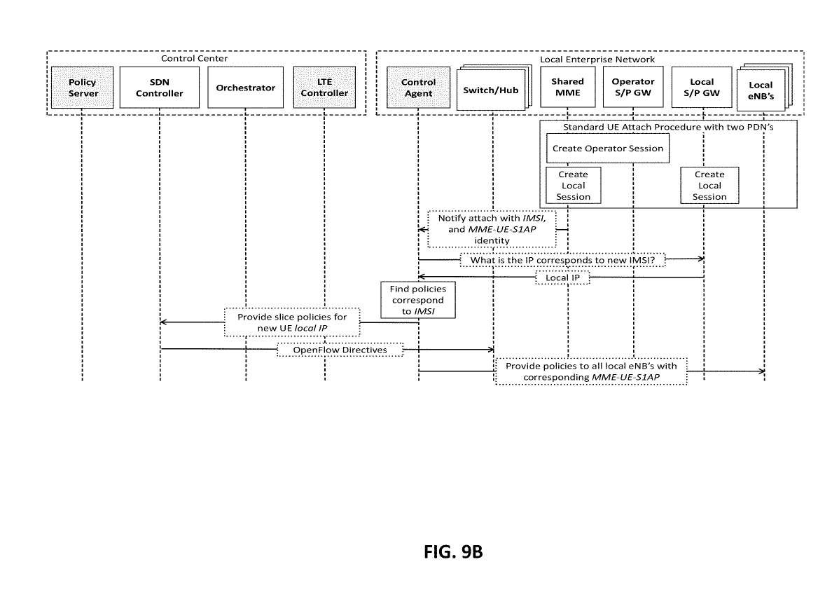

FIGS. 9a and 9b illustrate example message flow diagrams for introduction of new policies to the enterprise network and implementation of pre-defined policies during a UE's connection establishment (so called attach request). In FIG. 9a, a policy update can be referred as addition, removal, or configuration modification of a slice. The configuration modification can include but not limited to adding/removing UE IMSI's from a slice, changing type of WAN, updating VNF scale, and updating radio resource percentage. Depending on the policy update, policy server is responsible to forward the new policy requirements to at least one of the SDN controller, orchestrator, and LTE controller. SDN controller is responsible to generate new OpenFlow directives and sending these directives to the local switches for load balancing and routing towards the desired WAN type. The orchestrator is responsible of starting, stopping and scaling the local virtual functions horizontally or vertically. A new policy update on a slice may require starting a DPI or NAT function or scaling up CPU and RAM usage of virtual MME and S/P-GWs. The LTE controller is responsible for forwarding radio properties of slices to the control agents, which in turn implements the slice properties in real-time. According to policy update, control agent directly forwards IMSI admission list update to virtual MME, and static radio policy updates to the local eNB's. The admission control of the enterprise cellular system is directed by virtual MME with its internal IMSI admission list. As the aforementioned enterprise network is intended to provide service to only pre-determined UE's, their admission is controlled by their IMSI's. Hence, control agent updates IMSI admission list in the virtual MME, when a new UE is permitted to connect, or when connection of an existing UE is blocked. When a connection attempt comes from a UE that is not present in the IMSI list, MME rejects the attachment with a pre-defined reject cause. In the policy update, control agent also forwards static slice policy updates to local eNB's such as slice radio resource percentage or handover parameter change.

FIG. 9b illustrates the real-time messaging sequence within the aforementioned enterprise system when a UE connects. When a UE whose IMSI is (a) from Operator A and (b) in the admission list of the virtual MME (of Operator A) attempts to connect to one of the local HeNB's, first the ‘attach procedure’ is completed through that virtual MME, remote (Operator A's) HSS, local S-GW and remote (Operator A's) P-GW. A tunnel (layer 2 connection) is established between the UE and the Operator A's P-GW, which assigns an IP address to the UE. For the local routing of the UE traffic, i.e., for the local destinations, an additional IP session is created with the local P-GW, which assigns an additional IP address to the UE only for local forwarding. The additional local P-GW session can be initiated by (1) treating the remote operator HSS as a second PDN network or (2) an additional default configuration of the virtual MME (that forces local connections only through the local P-GW). In both cases, the local P-GW provides a new IP address to the UE from the local enterprise IP pool and creates a bearer with a Traffic Flow Template (TFT) IP filter for the local network routing. Therefore, the UE uses its local bearer and local IP address to communicate with all other local UEs (local numbered, Operator A and B UEs), and the operator bearer and operator provided IP address to communicate with the remaining destinations via the remote P-GW.

For interoperability with the control agent, an important responsibility of the virtual MME is to notify control agent in each case of UE attach and detach. Even though the unchanging unique identity of each UE is the IMSI, HeNB's are not capable or allowed for security reasons of storing IMSI's of the connected UE's. A standard HeNB can maintain several temporary identities for a connected UE. In this example scenario, we assume virtual MME notifies the control agent the ‘UE attach’ with IMSI and MME-UE-S1AP identities. MME-UE-S1AP is a temporary id that is maintained in both HeNB and virtual MME for control connection. Control agent identifies the slice that UE belongs by the UE's IMSI and sends RAN slice policies along with MME-UE-S1AP to HeNB.

P-GW-assigned IP address to a UE dictates the routing and QoS policies for that UE, i.e., becomes an indicator of its network slice. There are different embodiments to achieve IP addressing:

(a) P-GW first assigns an available local IP address to the UE from a general pool of available IP addresses, and then notifies the control agent, which in turn notifies the SDN controller of the newly assigned local IP to the UE (for example, using an OpenFlow packetIN message) so that the SDN controller can send the SDN switch the configuration corresponding to that newly assigned IP address according to the slice of the UE for traffic load balancing, prioritization or WAN selection.

(b) P-GW can be pre-configured with different IP address pools corresponding to IMSI pools (each IMSI pool representing a user-group) by the control agent at the time of provisioning, wherein each IP address pool corresponds to a specific network slice, which implies different treatment within the local network. The SDN switch may also be pre-configured with those IP address pools for proper routing, and QoS treatment. In this scenario, the slices are essentially pre-configured for the group of IMSI corresponding to a user-group, and thus no new action is needed from the SDN controller. The P-GW selects an IP address from the pool corresponding to user's assigned user-group.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of a system and method for an integrated virtual customer premises equipment. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1- A slicing method for customer premises equipment (CPE), wherein each user-group or application type is mapped to a local network slice according to a profile, wherein slicing provides a subdivision of all network resources associated with the CPE comprising a local radio access network (RAN) and an associated local core network (CN), a local area network (LAN), at least one virtualized network function (VNF), and at least one programmable switch, the method executed by a special control agent comprising the steps of:
(a) receiving directives to control the control agent from a control infrastructure hosted in a remote site, the remote site storing user-group information and associated profiles, and
(b) slicing components of the CPE according to the storing user-group information and associated profiles by assigning different network resources to user groups by programing any of, or a combination of the following: the local RAN, Mobility Management Entity (MME) and Packet Data Network Gateway (P-GW) components of the local CN, the at least one VNF, and the at least one programmable switch.

2- The slicing method of claim 1, wherein the user-groups have different user equipment (UE), the UE comprising any of the following: cell phone, tablet, personal computer, server, and one or more sensors that are IP numbered and attached to the public internet using cellular, wire line and/or wireless connections.

3- The slicing method of claim 2, wherein the cellular connection comprises an International Mobile Subscriber Identity (IMSI) number that is matched with either a locally assigned, private, telephone number by a local network or another telephone number assigned by a mobile operator.

4- The slicing method of claim 1, wherein the CPE is attached to the Public Internet using any of the following types of wide area network (WAN) connections: DSL, Cable, metro fiber, private line, and Multiprotocol Label Switching (MPLS) based network.

5- The slicing method of claim 1, wherein the core network has a connection to at least one mobile operator if there is a pool of local UEs with telephone numbers assigned by the at least one mobile operator.

6- The slicing method of claim 5, wherein the connection is achieved by deploying a virtual Mobility Management Entity (MME) and a virtual serving gateway (S-GW) within the local core network, the virtual MME and the virtual S-GW being attached to a core network associated with the at least one mobile operator to route traffic between local UEs and remote UEs, and acts as a MME and S-GW for the local core network.

7- The slicing method of claim 6, wherein slicing of RAN is achieved by (i) the virtual MME notifying the control agent when a UE attaches with International Mobile Subscriber Identity (IMSI) and a temporary MME-UE-S1AP identity, (ii) the control agent identifying the slice of that UE by its IMSI and (iii) sending RAN slice policies along with MME-UE-S1AP to the local base station.

8- The slicing method of claim 1, wherein the programmable switch is a Software Defined Networking (SDN) switch.

9- The slicing method of claim 8, wherein the control agent programs the SDN switch according to a given UE's IP address.

10- The slicing method of claim 8, wherein SDN switch slicing is achieved for cellular traffic by (i) a Packet Data Network Gateway (P-GW) first assigning an available local IP address to a given UE that attaches, where the local IP address is assigned from a general pool of available IP addresses, and (ii) notifying the control agent, which in turn notifies a SDN controller of the assigned local IP to the given UE, and (iii) the SDN controller sending a corresponding flow-table to the control agent or directly to the at least one programmable switch.

11- The slicing method of claim 8, wherein SDN switch slicing is achieved for cellular traffic by (i) a Packet Data Network Gateway (P-GW) assigning an IP address to a given UE that attaches, where the IP address is assigned from a pre-configured IP address pool reserved for a specific user-group, wherein the at least programmable switch is pre-configured by a SDN controller or the control agent with the flow-tables corresponding to an associated user-group profile.

12- The slicing method of claim 1, wherein the VNF is any of the following: a firewall, a NAT, an email service, and a web service.

13- The slicing method of claim 1, wherein slicing for a given user-group is based on a fixed identity of a UE associated with that given user-group, where the fixed identity is any of the following: an International Mobile Subscriber Identity (IMSI), a Media Access Control Address (MAC) address, and an username and password.

14- The slicing method of claim 1, wherein slicing for a given user-group is based on an IP address of an UE assigned from an address pool assigned to members of a given slice.

15- The slicing method of claim 1, wherein the method comprises the step of slicing the RAN by the control agent by sending at least an allocated uplink and downlink resource blocks for a slice-specific user plane, and associated uplink and downlink schedulers selected from a list of available schedulers for each user group according to a given UE's International Mobile Subscriber Identity (IMSI).

16- The slicing method of claim 1, wherein the slicing is achieved by allocating slices of Mobility Management Entity (MME) or Virtual Serving Gateway/Packet Data Network Gateway (S/P-GW) resources according to an attached UE's IP addresses or International Mobile Subscriber Identity (IMSI).

17- The slicing method of claim 1, wherein slicing of the VNF is achieved by allocating server resources, said server resources comprising at least processing and memory according to user UE's IP address.

18- A system providing a sliceable local communications network further providing wire line, wireless, and cellular data communications services to a group of users, and that is comprised of at least a local area network (LAN), a local Radio Access Network (RAN) and associated local core network (CN) and at least one programmable switch interconnecting the local CN, a local data network and at least one wide area network (WAN), wherein customer premises equipment (CPE) is controlled by a local control agent, which is in communications with a remote control center, wherein groups of users of the CPE with different profiles are given different slices of the RAN, CN, at least one programmable SDN switch, at least one virtualized network function (VNF), and transport facilities, the system comprising:
(a) a policy server of the remote control center that stores user-group policies and associated UE data such as UE International Mobile Subscriber Identity (IMSI), Media Access Control (MAC) address, and username/password;
(b) an orchestrator of the remote control center programmed by the policy server to control either the control agent or the VNF directly by sending directive to slice the VNF;
(c) an SDN controller of the remote control center programmed by the policy server to control the control agent or the at least one programmable SDN switch directly by sending directive to slice the at least one programmable switch;
(d) a Long-Term Evolution (LTE) controller of the remote control center programmed by the policy server to send directives to the control agent for slicing a Mobility Management Entity (MME), the RAN and a Packet Data Network Gateway (P-GW); and
(e) the control agent residing within the customer premises equipment:
(i) receiving directives from the remote control center, and (i)) applying said directives to local network components.

19- An article of manufacture comprising non-transitory computer storage medium storing computer readable program code which, when executed by a processor in a single node, implements a slicing method for customer premises equipment (CPE), wherein each user-group or application type is mapped to a local network slice according to a profile, wherein slicing provides a subdivision of all network resources associated with the CPE comprising a local radio access network (RAN) and an associated local core network (CN), a local area network (LAN), at least one virtualized network function (VNF), and at least one programmable switch, the medium comprising:
(a) computer readable program code executed by the processor to receive directives to control the control agent from a control infrastructure hosted in a remote site, the remote site storing user-group information and associated profiles, and
(b) computer readable program code executed by the processor to slice components of the CPE according to the storing user-group information and associated profiles by assigning different network resources to user groups by programing any of, or a combination of the following: the local RAN, Mobility Management Entity (MME) and Packet Data Network Gateway (P-GW) components of the local CN, the at least one VNF, and the at least one programmable switch.
